(19) United States
(12) Patent Application Publication
(10) Pub. No.: US 2015/0169181 A1
(43) Pub. Date: Jun. 18, 2015

(54) SHIELDING METHOD FOR A PART OF A SCREEN AND PORTABLE TERMINAL USING THE SAME

(71) Applicant: Samsung Electronics Co., Ltd., Suwon-si (KR)

(72) Inventors: Feifei WANG, Tianjin (CN); Maoda XU, Tianjin (CN)

(21) Appl. No.: 14/448,057

(22) Filed: Jul. 31, 2014

(30) Foreign Application Priority Data
Dec. 16, 2013 (CN) 201310715108.4

(51) Int. Cl. G06F 3/0481; G06F 3/0484

(52) U.S. Cl. CPC G06F 3/04817; G06F 3/0484

(57) ABSTRACT

A method for shielding a partial screen and a portable terminal using the same is provided. The method includes generating a shielding window having a predetermined size and shape in response to an input of a user, and setting a remaining area except for the generated shielding window on the screen of the portable terminal as a touch control area, wherein when a touch event occurs in the shielding window and the touch control area at a same time, the touch event that is occurred in the shielding window is omitted.

### CROSS-REFERENCE TO RELATED APPLICATION(S)

This application claims the benefit under 35 U.S.C. §119(a) of a Chinese patent application filed on Dec. 16, 2013 in the State Intellectual Property Office and assigned Serial number 201310715108.4, the entire disclosure of which is hereby incorporated by reference.

### TECHNICAL FIELD

The present disclosure relates to a shielding method for a part of a screen and a portable terminal using the same. More particularly, the present disclosure relates to a shielding method for a part of a screen which can shield touch operations in any partial area on a screen of the portable terminal and a portable terminal applying the same.

### BACKGROUND

With the continuous development and perfection of intelligent operating systems, currently portable terminals can be used for realizing various functions such as playing games, watching videos, running office software, etc. Thus, in order to improve user experience, screens of portable terminals tend to become larger.

However, in order to further enlarge the screens without influencing the portability of the portable terminals themselves, currently the frames of a portable terminal would be narrowed down, thereby relatively increasing the size of the screen.

The advantages of this method of narrowing the frame lie in the overall size of the portable terminal not being increased, meanwhile, the narrowed frame may improve the aesthetic sense of the portable terminal.

However, the frame of a portable terminal may not only protect the display screen but also function indirectly to facilitate user in holding the portable terminal. FIG. 1 and FIG. 2 illustrate states of existing portable terminals according to the related art. That is, since all the current portable terminals use touch screens, the user needs to grab or hold the portable terminal using one hand (for example, the left hand) and perform an operation using the other hand (for example, the right hand). When the user, for example, grabs a side end of the portable terminal using the left hand, the user's fingers should keep away from the screen, i.e., the user's fingers should press the frame portion, because, as to the current touch screen, if a finger of the user's left hand presses the screen for a long period, the fingers of the right hand (or a stylus) cannot perform any input operation (i.e., the touch control operation cannot get responses).

Moreover, during actual usage, the heavy weight as well as and the narrow frame of the portable terminal having a large screen will make it difficult for the user to grab it with one hand. As a result, the portable terminal may often drop on the ground, causing injury to the user and damaging the portable terminal.

Nevertheless, under the related art, in order to keep the stability of the portable terminal, in a case where no other auxiliary structures are available around the user, the user has to move the finger into the screen area, though such means may often cause failure in operating the touch screen.

The above information is presented as background information only to assist with an understanding of the present disclosure. No determination has been made, and no assertion is made, as to whether any of the above might be applicable as prior art with regard to the present disclosure.

### SUMMARY

The present disclosure are to address at least the above-mentioned problems and/or disadvantages and to provide at least the advantages described below. Accordingly, an aspect of the present disclosure is to provide a method for shielding a part of the screen and a portable terminal using the same such that various operations in other area on the screen cannot be affected even if the user's hand presses a side of a display screen for a long period.

In accordance with an aspect of the present disclosure, a method for shielding a part of a screen of a portable terminal is provided. The method includes generating a shielding window having a predetermined size and shape in response to an input of a user, and setting a remaining area except for the generated shielding window on the screen of the portable terminal as a touch control area, wherein when a touch event occurs in the shielding window and the touch control area at a same time, the touch event that is occurred in the shielding window is omitted.

In accordance with an aspect of the present disclosure, a portable terminal is provided. The portable terminal includes a screen, a shielding window generating unit configured to generate a shielding window having a predetermined size and shape in response to the input of a user, and a control unit configured to set a remaining area except for the generated shielding window on the screen of the portable terminal as a touch control area, wherein, when a touch event occurs on the shielding window and the touch control area at a same time, the control unit omits the touch event that is occurred in the shielding window.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates states of using existing portable terminals according to the related art.

FIG. 2 illustrates states of using existing portable terminals according to the related art.

FIG. 3 is a schematic diagram of the portable terminal according to an embodiment of the present disclosure.

FIG. 4 is a block diagram illustrating the constitution of a touch-type portable terminal according to an embodiment of the present disclosure.

FIGS. 5A, 5B and 5C are figures illustrating the state of using the portable terminal according to an embodiment of the present disclosure.

FIG. 6 is a flowchart of the partial screen shielding method according to an embodiment of the present disclosure.

FIG. 7 is a flowchart of a method for generating the shielding window according to an embodiment of the present disclosure.

FIG. 8 is flowchart of another method for generating a shielding window according to an embodiment of the present disclosure.

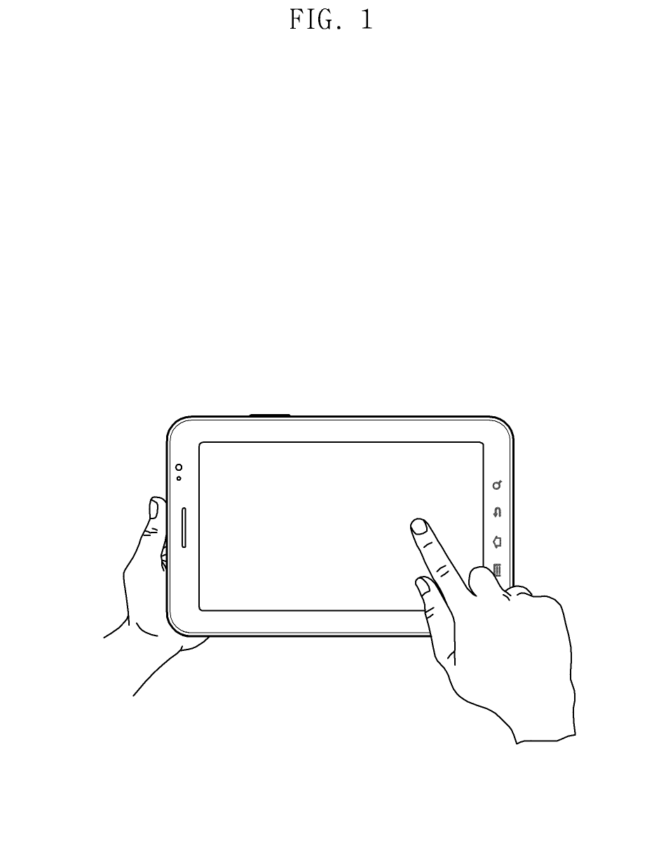

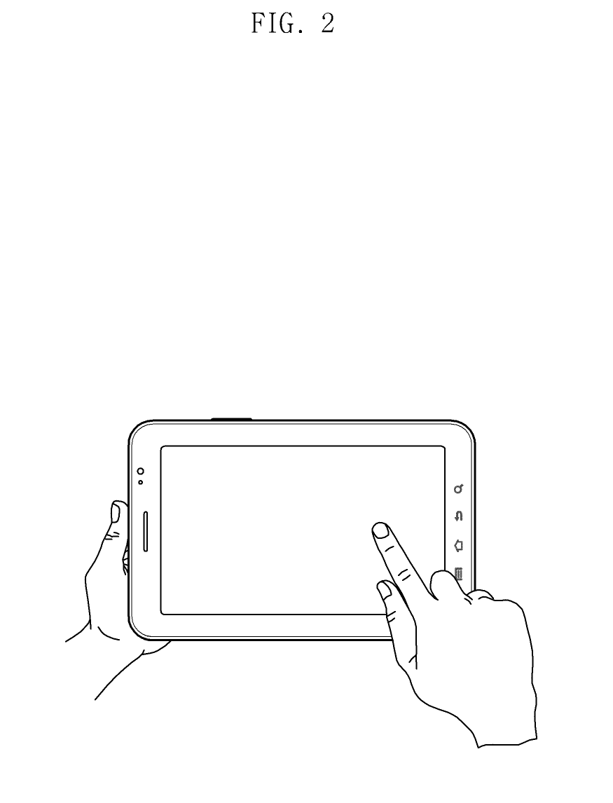

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness. Further, for example, the portable terminal may be embodied as a panel personal computer (PC).

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

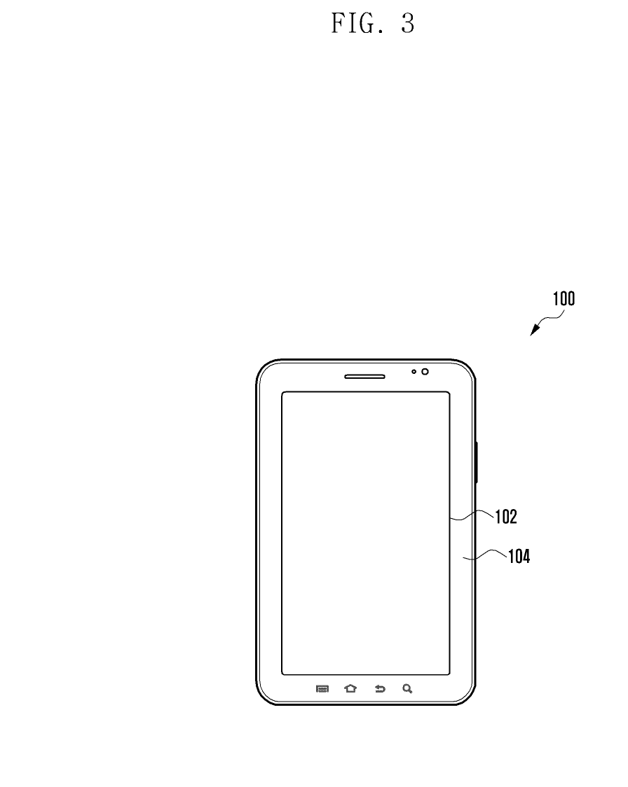

FIG. 3 is a schematic diagram of the portable terminal 100 according to an embodiment of the present disclosure. As illustrated in FIG. 3, the portable terminal 100 according to the present disclosure includes a display screen 102 and a frame 104 provided at the periphery of the display screen 102.

The display screen 102 is a touch screen, thus the user may not only view various pictures through the display screen 102, but also input various operation instructions via the display screen 102, i.e., the display screen 102 may be an input unit as well. The display screen 102 may be touch screens used by various means, such as a vector pressure sensing touch screen, a resistive touch screen, a capacitive touch screen, an infrared touch screen, and a surface acoustic wave touch screen.

In order to provide and protect such display screen 102, the frame 104 is provided at the periphery of the display screen 102. The frame 104 may be further provided with a physical button (for example, a power button) at a predetermined position thereof The frame 104 may have a random width, i.e., the width of the frame 104 may infinitely decrease on the premise of being able to provide sufficient protection for the display screen 102. The frame 104 is made of a transparent material or a metal material.

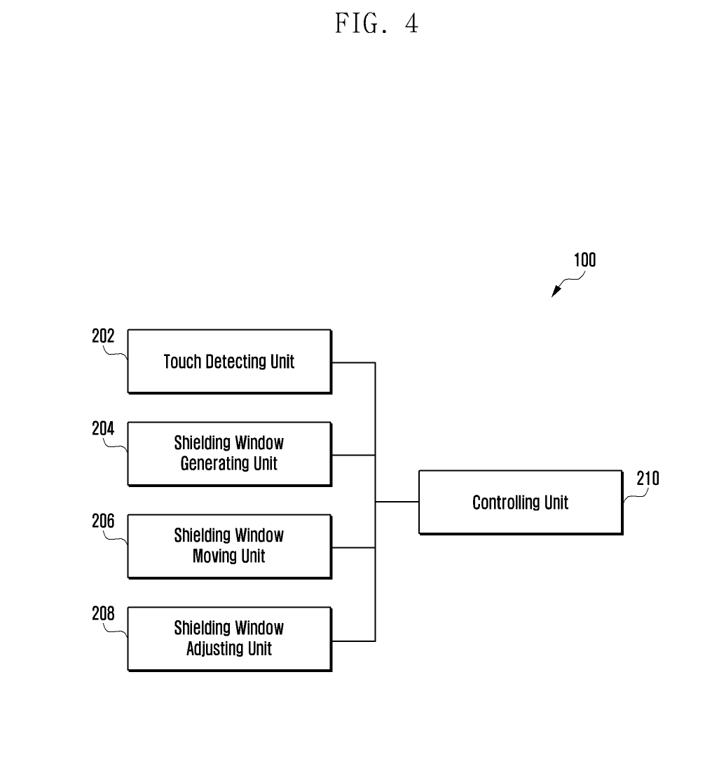

FIG. 4 is a block diagram illustrating a touch-type portable terminal 100 according to an embodiment of the present disclosure. The portable terminal 100 according to the present disclosure may further include a touch detecting unit 202, a shielding window generating unit 204, a shielding window moving unit 206, a shielding window adjusting unit 208, and a controlling (e.g., control) unit 210.

The touch detecting unit 202 may detect touch event to the display screen 102 performed by the user. For example, the touch detecting unit 202 may sense a touch event on the display screen 102 of the display screen according to signals from various sensors and determine whether the touch event is a click touch event or a sliding touch event at the same time. Moreover, when the touch event is a click touch event, the touch detecting unit 202 may further calculate a time duration of the click touch event. The operation of the user to the display screen 102 may be determined as a short touch or a long-time press by calculating the time duration of the click touch event.

The touch detecting unit 202 may further include a touch coordinate detecting unit (not illustrated in the figures). The touch coordinate detecting unit may detect the coordinate of the position where the touch event occurs. It may be determined whether the touch event to the display screen 102 performed by the user is a click touch event or a sliding touch event via the touch coordinate detecting unit.

The shielding window generating unit 204 is used for generating the shielding window. At this time, the shielding window generating unit 204 may generate a shielding window having a predetermined size and shape in response to the manual input of the user. For example, the shielding window generating unit 204 generates the shielding window having the predetermined size and shape at any position of the display screen 102 when it is detected that the user has activated the application for generating the shielding window. At this time, obviously the user may further delete the generated shielding window manually via the shielding window generating unit 204.

Moreover, the shielding window generating unit 204 may automatically generate the shielding window having the predetermined shape and size according to a signal from the touch detecting unit 202. Specifically, when the touch detecting unit 202 detects a click touch event of the user which exceeds a predetermined time, the shielding window generating unit 204 may generate the shielding window having the predetermined shape and size in the vicinity of the position (the position where the touch event occurs) touched by the user according to corresponding signal output by the touch detecting unit 202. Accordingly, when the hand (for example, the left hand) of the user enters into the screen area of the portable terminal 100 to grab the same, the shielding window having the predetermined size may be automatically generated at the position touched by the user, so as to improve the using convenience of the user.

For example, the shielding window generating unit 204 may automatically generate the shielding window having the predetermined shape and size centered at the touch point when the touch event is a single-point touch event. Moreover, when the touch event is a two-point touch event, the shielding window generating unit 204 may automatically generate a shielding window having a rectangular shape or a circular shape with a connecting line of the two points as a diagonal line or a diameter. Accordingly, the needed size of the shielding window may be determined while generating the shielding window. Moreover, when the touch event is a large-area touch event having more than two points, the shielding window generating unit 204 may generate a shielding window having a predetermined shape surrounding the touched positions around the user touched positions.

When the user does not touch the shielding window any longer in a predetermined time, the shielding window generating unit 204 may automatically delete the shielding window.

In the present disclosure, the shielding window refers to an invalid operation shielding area formed on the display screen 102 of the portable terminal 100. That is, at predetermined conditions, touch events occurred on the shielding window will be omitted. For example, when one hand (for example, the left hand) of the user contacts the display screen 102 by touching the shielding window, and the other hand (for example, the right hand) performs an input, the control unit 210 sets the remaining area on the display screen 102 except the shielding window as the touch control area to perform operations corresponding to the input instruction, and to omit the touch on the shielding window. The shielding window is a translucent floating window.

Moreover, when the user performs an operation to the display screen 102 using only one hand, and the other hand does not touch the shielding window, touch events of the shielding window will not be omitted, i.e., the control unit 210 may execute various operations to the shielding window, for example, adjusting the shape (various shapes such as a circular shape, a rectangular shape, etc.), transparency, size, brightness, color, etc. of the shielding window.

That is, when both hands of the user touch the display screen 102 of the portable terminal 100, and one hand thereof touches the shielding window, the control unit 210 omits touches on the shielding window, while, when only one hand (one finger or a stylus) touches the display screen 102, the control unit 210 performs various operations rather than omitting the touches on the shielding window.

The shielding window moving unit 206 is used for moving the shielding window generated by the shielding window generating unit 204. That is, when the control unit 210 does not omit the touches on the shielding window any more, the shielding window moving unit 206 may move the shielding window to the predetermined position on the display screen 102 in response to the dragging of the user.

Moreover, the present disclosure may further include a fixing unit (not illustrated in the figures) for fixing the position of the shielding window. For example, when the user moves the shielding window to the predetermined position via the shielding window moving unit 206 then performs a double click, etc., the shielding window fixing unit may fix the shielding window to the position. Meanwhile, with respect to the fixed shielding window, the fixing state may be canceled by operations such as a double click.

The shielding window adjusting unit 208 is used for adjusting parameters such as the shape, transparency, size, brightness, color, etc. of the shielding window. That is, when the control unit 210 does not omit the touches on the shielding window any more, the shielding window adjusting unit 208 may adjust parameters such as the shape, transparency, size, brightness, color, etc. of the shielding window according the input from the user. At this time, the shielding window may be in various shapes such as a rectangle, a circle, an oval, a custom shape, and etc.

When the shielding window generating unit 204 generates a shielding window or the shielding window moving unit 206 moves the generated shielding window, the shielding window may cover an icon at corresponding position in a form of a floating window or may squeeze the icon at the corresponding position to the other area (the remaining area) on the display screen 102 except the shielding window.

The portable terminal 100 may further include an icon arranging unit (not illustrated in the figures) configured to automatically realign and rearrange all the icons in the remaining area when the icon at the corresponding position is squeezed to the remaining area.

The control unit 210 is used to control various operations of the portable terminal 100. The control unit 210 may set the remaining area outside the shielding window on the display screen 102 of the portable terminal 100 as the touch control area. Accordingly, when touch events occur in the shielding window and the touch control area at the same time, the control unit 210 omits touch events occurred on the shielding window. Thus, when one user's hand grabs the portable terminal 100 via the shielding window, the control unit 210 may perform the operation to the remaining area via the other hand (a finger or a stylus).

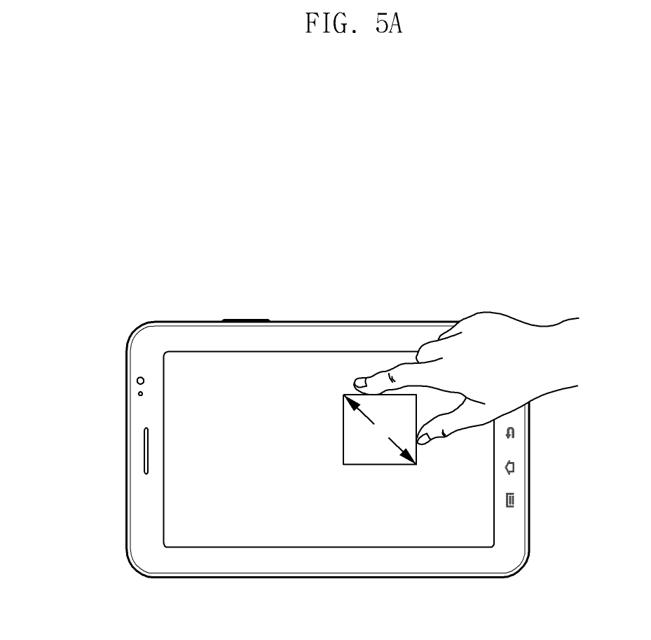

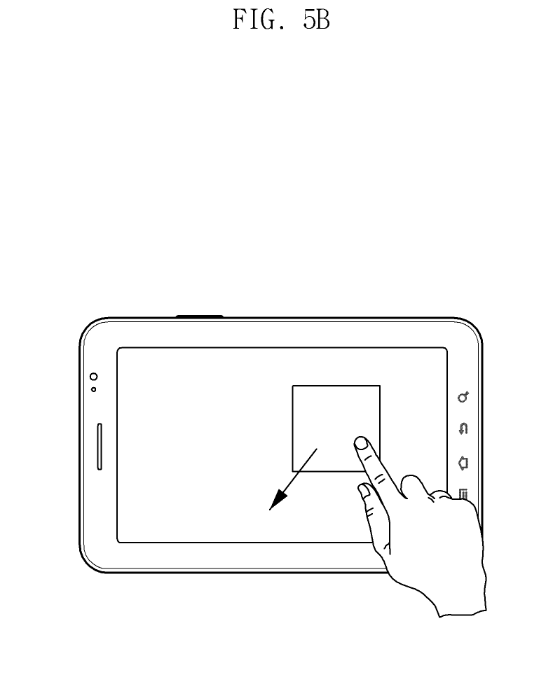

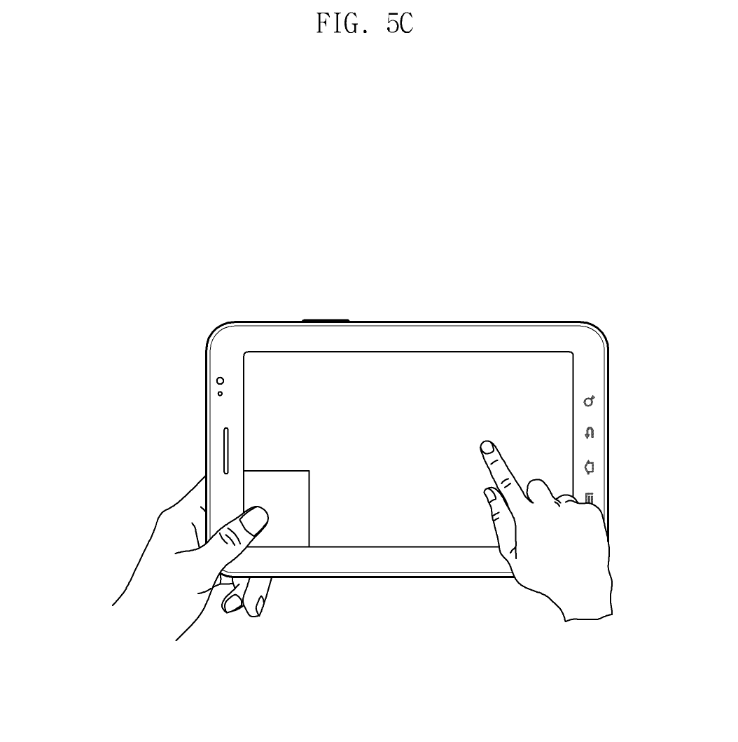

FIGS. 5A to 5C illustrate a state of using the portable terminal 100 according to an embodiment of the present disclosure. Thus it can be seen that through the above shielding window, even if the finger of the user enters into the screen area to press a side of the display screen 102 for a long period, various operations performed to another area of the display screen 102 by the other hand will not be affected.

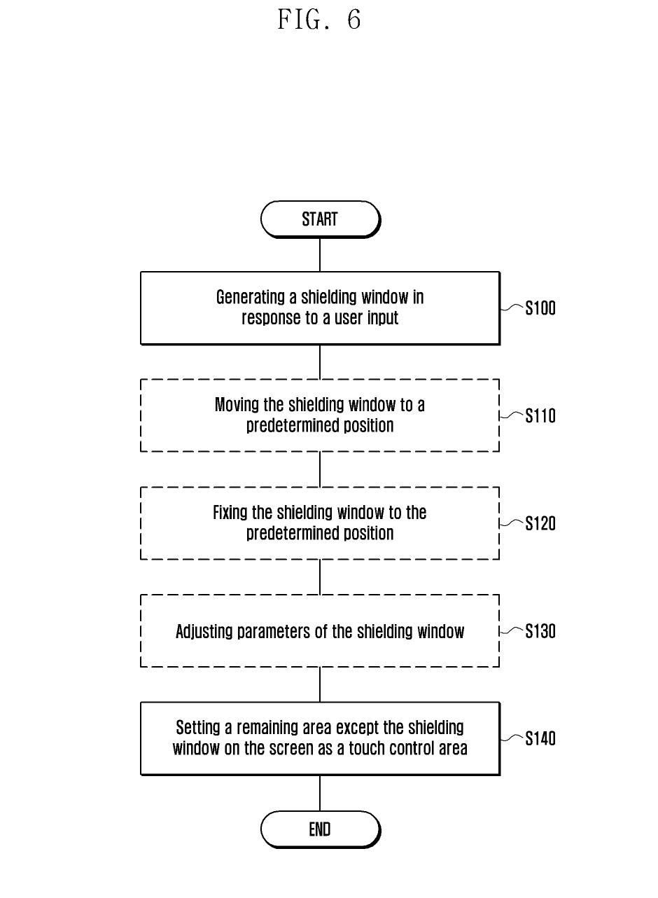

FIG. 6 is a flowchart of the partial screen shielding method according to an embodiment of the present disclosure.

At operation S100, a shielding window having a predetermined size and shape is generated on the display screen 102 in response to an input of a user. At this time, manual input means such as a physical button and so on may be used for generating a user instruction for generating the shielding window so as to activate an application for generating the shielding window, or the shielding window may be automatically generated by pressing the display screen 102 for a long period.

At this time, the shielding window may cover the icon at corresponding position in a form of a floating window or squeeze the same to the remaining area except the shielding window when the shielding window is generated. Moreover, all the icons in the remaining area may be realigned and rearranged in the remaining area when the icon at the corresponding position is squeezed to the remaining area.

Then, selectively entering operation S110, i.e., moving the generated shielding window to a predetermined position (for example, an edge position on the display screen 102 close to the frame of the portable terminal 100) on the display screen 102 in response to the dragging of the user. It is noteworthy that operation S110 may be omitted when the generated shielding window does not need to be adjusted.

Subsequently, selectively entering operation S120, i.e., fixing the shielding window at the predetermined position. At this time, the position of the shielding window may be fixed through simple actions such as a double click and so on. It is noteworthy that this operation may be omitted when the shielding window does not need to be fixed to the predetermined position.

Subsequently, selectively entering operation S130, i.e., adjusting at least one of the parameters such as the size, shape, transparency, color, and brightness of the shielding window. At this time, respective parameters set when using the shielding window for the first time may be stored, thus the adjusting may be completed only by reading the next time when using the shielding window. It is noteworthy that this operation may be omitted when the at least one of the parameters such as the size, shape, transparency, color, and brightness of the shielding window does not need to be adjusted.

Next, entering operation S140, i.e., setting the remaining area except the shielding window on the display screen 102 of the portable terminal 100 as the touch control area. At this time, when touch events occur in the shielding window and the touch control area at the same time, touch events occurred on the shielding window are omitted. Thus it can be seen that, even if the finger of the user enters into the screen area to press a side of the display screen 102 for a long period, various operations performed to another area of the display screen 102 by the other hand will not be affected.

Meanwhile, in the above description, although operation S130 may be performed after performing the operation S110, according to actual needs, operation S130 may also be performed after the operation S100.

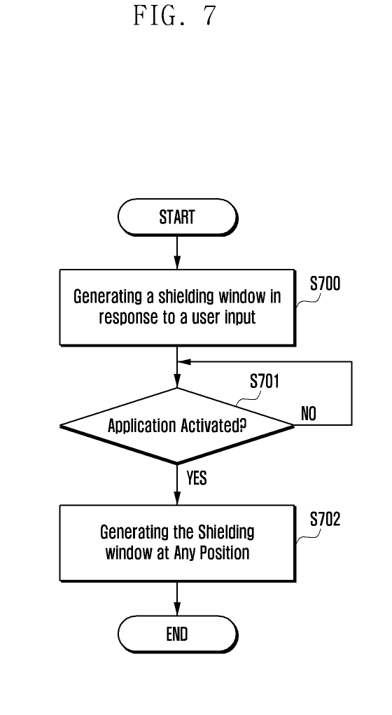

FIG. 7 is a flowchart of an embodiment of a method for generating the shielding window according to an embodiment of the present disclosure.

At operation S700, a shielding window having a predetermined size and shape is generated on the display screen 102 in response to an input of a user.

At operation S701, it is detected whether the user activates an application for generating the shielding window.

When it is determined in operation S701 that the user activates the application for generating the shielding window, operation S702 is performed to generate a shielding window having the predetermined size and shape at any position of the display screen 102.

Subsequently, the above-discussed operations S110, S120, and S130 may be selectively performed so as to adjust the shielding window.

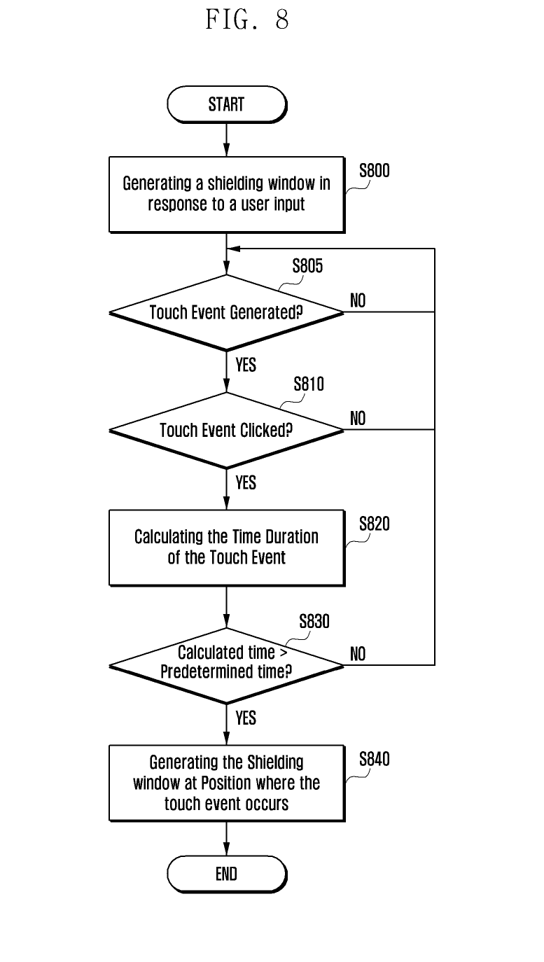

FIG. 8 is flowchart of an embodiment of the method for generating the shielding window according to an embodiment of the present disclosure.

Referring to FIG. 8, at operation S800, a shielding window having a predetermined size and shape is generated on the display screen 102 in response to an input of a user.

At operation S805, it is detected whether a touch event from the user is generated.

Entering operation S810, i.e., determining whether the touch event is a click touch event or a sliding touch event if the result of operation S805 is that the touch event from the user is generated.

Entering operation S820, i.e., calculating a time duration of the touch event if the result of operation S810 is that the touch event is a click touch event.

Subsequently, entering operation S830, i.e., determining whether the time calculated at operation S820 exceeds the predetermined time.

Entering operation S840, i.e., generating the shielding window having the predetermined shape and size at the position where the touch event occurs when the calculated time exceeds a predetermined time. For example, the shielding window having the predetermined shape and size may be automatically generated with the touch point as a center when the touch event is a single-point touch event. Moreover, when the touch event is a two-point touch event, the shielding window having a rectangular shape or a circular shape may be automatically generated with the connecting line of the two points as a diagonal line or a diameter. Accordingly, the needed size of the shielding window may be determined while generating the shielding window. Moreover, when the touch event is a large-area touch event having more than two points, the shielding window having the predetermined shape may be automatically generated surrounding the touched positions around the user touched positions.

At this time, the shielding window may be automatically deleted when the user does not touch the shielding window any longer in a predetermined time. Accordingly, the generated shielding window may be automatically deleted when the shielding window does not need to be used.

Furthermore, when the result of the operation S830 is that the time calculated at operation S820 is smaller than the predetermined time, the click touch event is determined as a normal click operation so as to perform a corresponding operation and return to operation S805.

Moreover, after generating a shielding window based on the position touched by the user, the following operations may be included adjusting at least one of the parameters such as the size, shape, transparency, color, and brightness of the shielding window.

Furthermore, the shielding window may cover the icon at corresponding position in a form of a floating window or squeeze the same to the remaining area except the shielding window when the shielding window is generated surrounding the position touched by the user. Moreover, all the icons in the remaining area may be realigned and rearranged in the remaining area when the icon at the corresponding position is squeezed to the remaining area.

Through the above operations, since the shielding window for shielding touch operations of the user may be provided at any position on the display screen 102 of the portable terminal 100, even if a finger of the user presses a the display screen 102 for a long period, various operations performed by another finger or the stylus on other area on the display screen 102 will not be affected.

While the present disclosure has been shown and described with reference to various embodiments thereof, it will be understood by those skilled in the art that various changes in form and details may be made therein without departing from the spirit and scope of the present disclosure as defined by the appended claims and their equivalents. For example, one or all of the above-described units could be comprised of one or more physical memories and/or one or more processors.

What is claimed is:

1. A method for shielding a part of a screen of a portable terminal, the method comprising:
generating a shielding window having a predetermined size and shape in response to an input of a user;
setting a remaining area except for the generated shielding window on the screen of the portable terminal as a touch control area,
wherein, when a touch event occurs in the shielding window and the touch control area at a same time, the touch event that is occurred in the shielding window is omitted.

2. The method of claim 1, wherein the generating of the shielding window having the predetermined size and shape in response to the input of the user further comprises:
detecting whether the user activates an application for generating the shielding window; and
generating the shielding window having the predetermined size and shape at any position of the screen when it is determined that the user has activated the application.

3. The method of claim 1, wherein the generating of the shielding window having the predetermined size and shape in response to the input of the user further comprises:
detecting whether the touch event from the user is generated;
determining whether the touch event is a click touch event or a sliding touch event if the touch event from the user is generated;
calculating a time duration of the touch event if the touch event is a click touch event; and
generating the shielding window having the predetermined shape and size on the screen with a position where the touch event occurs as a benchmark when the calculated time duration of the touch event exceeds a predetermined time.

4. The method of claim 3,
wherein, when the determining of whether the touch event is the click touch event or the sliding touch event determines that the touch event is the sliding touch even, the detecting of whether the touch event from the user is generated again comprises detecting whether another touch event from the user is generated, and
wherein, when the time duration calculated by the calculating of the time duration does not exceed the predetermined time, the detecting of whether the touch event from the user is generated again comprises detecting whether another touch event from the user is generated.

5. The method of claim 1, further comprising moving the shielding window to a predetermined position on the screen in response to a dragging of the user.

6. The method of claim 5, further comprising fixing the shielding window at a predetermined position.

7. The method of claim 1, further comprising adjusting at least one of a size, shape, color, transparency, and brightness of the shielding window.

8. The method of claim 1, further comprising covering an icon at a corresponding position in a form of a floating window or squeezing the icon at the corresponding position to a remaining area.

9. The method of claim 8, further comprises realigning and rearranging all icons in the remaining area when the icon at the corresponding position is squeezed to the remaining area.

10. A portable terminal comprising:
a screen;
a shielding window generating unit configured to generate a shielding window having a predetermined size and shape in response to an input of a user;
a control unit configured to set a remaining area except for the generated shielding window on the screen of the portable terminal as a touch control area,
wherein, when a touch event occurs to the shielding window and the touch control area at a same time, the control unit omits the touch event that is occurred in the shielding window.

11. The portable terminal of claim 10, wherein the shielding window generating unit is configured to generate the shielding window having the predetermined size and shape at any position of the screen when it is detected that the user has activated an application for generating the shielding window.

12. The portable terminal of claim 10, further comprising:
a touch detecting unit configured to sense a touch event, to determine whether the touch event is a click touch event or a sliding touch event, and to calculate a time duration of the click touch event,
wherein the shielding window generating unit generates the shielding window having the predetermined shape and size on the screen with a position where the touch event occurs as a benchmark when the calculated time duration of the touch event exceeds a predetermined time.

13. The portable terminal of claim 10, further comprising a shielding window moving unit configured to move the shielding window to a predetermined position on the screen in response to a dragging of the user.

14. The portable terminal of claim 13, further comprising a shielding window fixing unit configured to fix the shielding window at the predetermined position.

15. The portable terminal of claim 10, further comprising a shielding window adjusting unit configured to adjust at least one of a size, shape, color, transparency, and brightness of the shielding window.

16. The portable terminal of claim 10, wherein an icon is covered at corresponding position in a form of a floating window or the icon is squeezed at a corresponding position to the remaining area when the shielding window is generated.

17. The portable terminal of claim 16, further comprising an icon arranging unit configured to realign and rearrange all icons in the remaining area when the icon at the corresponding position is squeezed to the remaining area.
